(19) United States
(12) Patent Application Publication
(10) Pub. No.: US 2009/0029161 A1
(43) Pub. Date: Jan. 29, 2009

(54) Pressure-sensitive adhesive composition, pressure-sensitive adhesive layer, and pressure-sensitive adhesive sheet

(75) Inventors: Yasunori Karasawa, Tokyo (JP); Mikihiro Kashio, Tokyo (JP); Masahito Nakabayashi, Tokyo (JP); Mamoru Kobayashi, Tokyo (JP)

Correspondence Address: BIRCH STEWART KOLASCH & BIRCH, PO BOX 747, FALLS CHURCH, VA, 22040-0747, US

(73) Assignee: LINTEC Corporation, Tokyo (JP)

(21) Appl. No.: 12/219,064

(22) Filed: Jul. 15, 2008

(30) Foreign Application Priority Data
Jul. 17, 2007 (JP) 2007-185587

(51) Int. Cl. B32B 27/36; C08F 120/18

(52) U.S. Cl. 428/355 AC; 526/329.7

(57) ABSTRACT

The present inventions are a pressure-sensitive adhesive composition comprising a poly(meth)acrylate compound that contains a repeating unit shown by the following formula (1) in its molecule and has a melting point of 50° C. or less; a pressure-sensitive adhesive layer comprising a crosslinked product of the pressure-sensitive adhesive composition; and a pressure-sensitive adhesive sheet comprising the pressure-sensitive adhesive layer and a support, the pressure-sensitive adhesive layer being provided on one side or both sides of the support material.

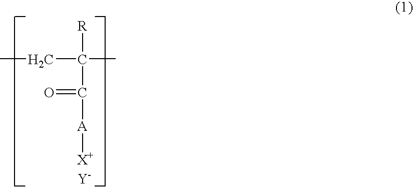

wherein X⁺ and Y⁻ represent a combination of a counter cation and a counter anion which may form an ion pair, R represents a hydrogen atom or a methyl group, and A represents a linking group.

### BACKGROUND OF THE INVENTION

1. Field of the Invention

The present invention relates to a pressure-sensitive adhesive composition containing a polymerized ionic liquid, a pressure-sensitive adhesive layer obtained by crosslinking the composition, and a pressure-sensitive adhesive sheet including the pressure-sensitive adhesive layer.

2. Description of Related Art

A surface protective film is used to prevent a flaw or a stain which occurs when processing or transporting a protection target object. For example, a surface protective film is bonded to an optical member (e.g., polarizing plate or wave plate) used for liquid crystal displays through a pressure-sensitive adhesive in order to prevent a flaw or a stain. The protective film is removed from the optical member when the surface protective film has become unnecessary (e.g., the optical member has been bonded to a liquid crystal cell).

The surface protective film and the optical member are formed of a plastic material, and exhibit high electrical insulating properties. Therefore, static electricity may easily occur when removing the protective film from the optical member such as a polarizing plate. When a voltage is applied to a liquid crystal in a state in which static electricity remains, the orientation of the liquid crystal molecules may be lost, or the panel may become defective. In order to prevent such a problem, the surface protective film is provided with various plate antistatic treatment.

As an antistatic treatment method, JP-A-H9-165460 discloses a method in which a low-molecular-weight surfactant is added to a pressure-sensitive adhesive, and the surfactant is transferred to an adherend from the pressure-sensitive adhesive to provide an antistatic effect, for example.

JP-A-H6-128539 discloses a method in which an antistatic agent containing a polyether polyol and an alkali metal salt is added to an acrylic pressure-sensitive adhesive so that the antistatic agent does not bleed out to the surface of the pressure-sensitive adhesive.

However, when using the method disclosed in JP-A-H9-165460 or JP-A-H6-128539 in which a low-molecular-weight surfactant or an antistatic agent is added to a pressure-sensitive adhesive, the surfactant or the antistatic agent still tends to bleed out to the surface of the pressure-sensitive adhesive. Therefore, the adhesion of the pressure-sensitive adhesive may decrease with the passage of time so that a peeling or floating phenomenon may occur, or an adherend may be contaminated when the pressure-sensitive adhesive is applied to a protective film.

In order to solve such a problem, JP-A-2006-104434 and JP-A-2006-152154 disclose pressure-sensitive adhesive compositions (pressure-sensitive adhesive) in which a base polymer (pressure-sensitive adhesive resin) contains an ionic liquid.

These pressure-sensitive adhesive compositions achieve a high antistatic effect and stable adhesion, and reduce contamination of an adherend (i.e., transfer of the pressure-sensitive adhesive when removed from an optical member).

However, since the pressure-sensitive adhesive compositions disclosed in JP-A-2006-104434 and JP-A-2006-152154 utilize a low-molecular-weight ionic liquid, when a pressure-sensitive adhesive layer formed of the pressure-sensitive adhesive composition is subjected to a high-temperature/high-humidity environment, the ionic liquid component may bleed out to the surface of the pressure-sensitive adhesive layer to contaminate the product.

### SUMMARY OF THE INVENTION

The present invention was conceived in view of the above-described situation of the related art. An object of the present invention is to provide a pressure-sensitive adhesive composition capable of forming a pressure-sensitive adhesive layer which exhibits a high antistatic effect and stable adhesion and does not contaminate an electronic component (i.e., a pressure-sensitive adhesive is not transferred to the electronic component when removed from the electronic component) even when subjected to a high-temperature/high-humidity environment, a pressure-sensitive adhesive layer obtained by crosslinking the composition, and a pressure-sensitive adhesive sheet including the pressure-sensitive adhesive layer.

The inventors of the present invention conducted extensive studies in order to solve the above-mentioned problems. The inventors prepared a pressure-sensitive adhesive composition containing a polymer compound obtained by synthesizing and polymerizing a (meth)acrylate derivative containing a counter cation site and a counter anion site and having the properties of an ionic liquid (hereinafter referred to as “polymerized ionic liquid”). The inventors found that this pressure-sensitive adhesive composition is capable of forming a pressure-sensitive adhesive layer which exhibits a high antistatic effect and stable adhesion and does not contaminate an electronic component (i.e., a pressure-sensitive adhesive is not transferred to the electronic component when removed from the electronic component) even when subjected to a high-temperature/high-humidity environment. This finding has led to the completion of the present invention.

According to a first aspect of the present invention, a pressure-sensitive adhesive composition described in (a) to (d) below is provided.

(a) A pressure-sensitive adhesive composition comprising a poly(meth)acrylate compound that contains a repeating unit shown by the following formula (1) in its molecule and has a melting point of 50° C. or less,

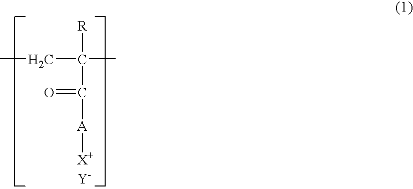

wherein X⁺ and Y⁻ represent a combination of a counter cation and a counter anion which may form an ion pair, R represents a hydrogen atom or a methyl group, and A represents a linking group.
(b) The pressure-sensitive adhesive composition according to (a), wherein X⁺ in the formula (1) is a nitrogen-containing onium, a sulfur-containing onium, or a phosphorus-containing onium.
(c) The pressure-sensitive adhesive composition according to (a) or (b), wherein A in the formula (1) is a group shown by *—(CH₂)ₙO— (wherein n represents an integer from 1 to 6, and * represents a position at which A is bonded to X⁺).
(d) The pressure-sensitive adhesive composition according to any one of (a) to (c), wherein the pressure-sensitive adhesive composition contains the poly(meth)acrylate compound in an amount of 0.01 to 50 wt % based on the total amount of the composition.

According to a second aspect of the present invention, a pressure-sensitive adhesive layer described in (e) below is provided.

(e) A pressure-sensitive adhesive layer comprising a crosslinked product of the pressure-sensitive adhesive composition according to any one of (a) to (d).

According to a third aspect of the present invention, a pressure-sensitive adhesive sheet described in (f) below is provided.

(f) A pressure-sensitive adhesive sheet comprising the pressure-sensitive adhesive layer according to (e) and a support, the pressure-sensitive adhesive layer being provided on one side or both sides of the support material.

According to the present invention, a pressure-sensitive adhesive composition capable of forming a pressure-sensitive adhesive layer which exhibits a high antistatic effect and stable adhesion and does not contaminate an electronic component (i.e., no transfer of a pressure-sensitive adhesive when removed from the electronic component) even when subjected to a high-temperature/high-humidity environment, a pressure-sensitive adhesive layer obtained by crosslinking the composition, and a pressure-sensitive adhesive sheet including the pressure-sensitive adhesive layer, are provided.

### DETAILED DESCRIPTION OF THE INVENTION AND PREFERRED EMBODIMENTS

1) The pressure-sensitive adhesive composition, 2) the pressure-sensitive adhesive layer, and, 3) the pressure-sensitive adhesive sheet according to the present invention are described in detail below.

### 1) Pressure-Sensitive Adhesive Composition

The pressure-sensitive adhesive composition according to the present invention comprises a poly(meth)acrylate compound that contains a repeating unit shown by the formula (1) in its molecule and has a melting point of 50° C. or less.

In the formula (1), X⁺ and Y⁻ represent a combination of a counter cation and a counter anion which may form an ion pair.

Preferred specific examples of the counter cation X⁺ include a nitrogen-containing onium, a sulfur-containing onium, and a phosphorus-containing onium. More preferred specific examples of the counter cation X⁺ are given below.

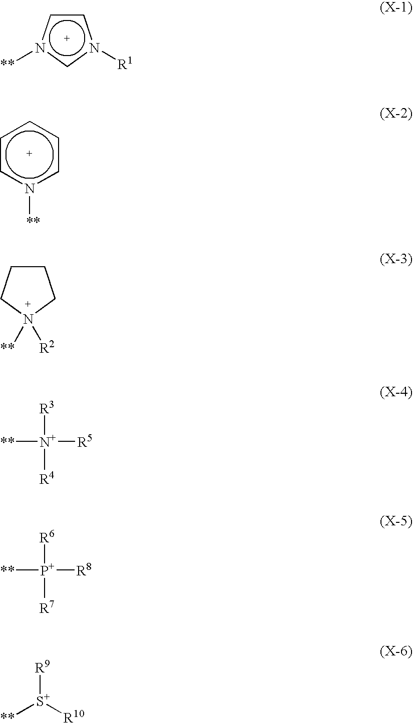

wherein R¹ to R¹⁰ individually represent a hydrogen atom or a hydrocarbon group having 1 to 20 carbon atoms which may have a substituent, and ** indicates the position at which the counter cation X⁺ is bonded to the linking group A.

Examples of the hydrocarbon group having 1 to 20 carbon atoms which may have a substituent, represented by R¹ to R¹⁰, include a methyl group, ethyl group, n-propyl group, isopropyl group, n-butyl group, isobutyl group, sec-butyl group, t-butyl group, n-pentyl group, neopentyl group, n-hexyl group, n-heptyl group, n-octyl group, n-nonyl group, n-decyl group, n-undecyl group, n-dodecyl group, and the like.

Examples of a substituent which may replace the above-mentioned hydrocarbon group having 1 to 20 carbon atoms include a phenyl group which may have a substituent, such as a phenyl group and a 4-methylphenyl group; alkoxy groups such as a methoxy group and an ethoxy group; halogen atoms such as a fluorine atom and a chlorine atom; and the like.

In the groups shown by the formulas (X-1) to (X-3), a substituent may be bonded to an arbitrary carbon atom of the nitrogen-containing heterocyclic ring. Examples of such a substituent include alkyl groups such as a methyl group and an ethyl group; a phenyl group which may have a substituent, such as a phenyl group and a 4-methylphenyl group; alkoxy groups such as a methoxy group and an ethoxy group; halogen atoms such as a fluorine atom and a chlorine atom; and the like.

The counter cation X⁺ is preferably an onium which is a heterocyclic group containing 1 to 3 nitrogen atoms in its ring, more preferably the group shown by the formula (X-1), (X-2), or (X-3), and particularly preferably the group shown by the formula (X-1).

Y⁻ is an anionic component of the polymerized ionic liquid.

The counter anion Y⁻ is not particularly limited insofar as an ionic liquid can be formed. Examples of the counter anion Y⁻ include Cl⁻, Br⁻, I⁻, AlCl₄⁻, Al₂Cl₇⁻, BF₄⁻, PF₆⁻, ClO₄⁻, NO₃⁻, CH₃COO⁻, CF₃COO⁻, CH₃SO₃⁻, CF₃SO₃⁻, (CF₃SO₂)₂N⁻, (CF₃SO₂)₃C⁻, AsF₆⁻, SbF₆⁻, NbF₆⁻, TaF₆⁻, F(HF)ₚ⁻ (wherein p represents an arbitrary natural number), (CN)₂N⁻, C₄F₉SO₃⁻, (C₂F₅SO₂)₂N⁻, C₃F₇COO⁻, (CF₃SO₂)(CF₃CO)N⁻, FeCl₄⁻, and the like. Among these, (CF₃SO₂)₂N⁻ is particularly preferable.

A represents a linking group. The linking group A is not particularly limited insofar as the linking group A has a function of linking the repeating unit shown by —[CH₂—CH(R)—C(═O)]— with the counter cation X⁺. Specific examples of the linking group A are given below.

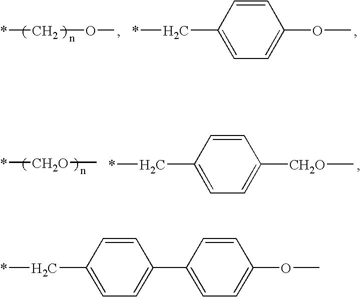

wherein n represents an integer from 1 to 6, and * has the same meaning as defined above.

Among these, the group shown by *—(CH₂)ₙO— (n and * have the same meaning as defined above) is preferable as the linking group A from the viewpoint of availability and the like.

R represents a hydrogen atom or a methyl group.

The poly(meth)acrylate compound used in the present invention may be (α) a homopolymer of one type of repeating unit shown by the formula (1), (β) a copolymer of two or more types of repeating units shown by the formula (1), or (γ) a copolymer of one or more types of repeating units shown by the formula (1) and one or more types of repeating units derived from other copolymerizable monomers copolymerizable with a (meth)acrylate compound shown by formula (2) described later (hereinafter may be referred to as “other copolymerizable monomers”).

In the poly(meth)acrylate compound used in the present invention, the ratio of the repeating units shown by the formula (1) to the repeating units derived from other copolymerizable monomers is not particularly limited. The weight ratio of the repeating units shown by the formula (1) to the repeating units derived from other copolymerizable monomers is normally 100:0 to 10:90.

The weight average molecular weight (Mw) of the poly(meth)acrylate compound used in the present invention is normally 1000 to 100,000, and preferably 1000 to 50,000.

The term “weight average molecular weight” used herein refers to the weight average molecular weight determined by gel permeation chromatography (GPC) (hereinafter the same).

The melting point of the poly(meth)acrylate compound used in the present invention is 50° C. or less, and preferably 40° C. or less.

### Process of Producing Poly(Meth)Acrylate Compound

The homopolymer (a) formed of only one type of repeating unit shown by the formula (1) which may be utilized as the poly(meth)acrylate compound used in the present invention may be produced by polymerizing a (meth)acrylate compound shown by the following formula (2) (hereinafter referred to as “(meth)acrylate compound (2)”).

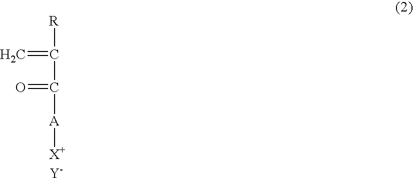

wherein R, A, X⁺, and Y⁻ have the same meanings as defined above.

The (meth)acrylate compound (2) may be obtained using a known ionic liquid production process such as a halide process disclosed in “Ionic liquid—Forefront of Development and Future” (published by CMC Publishing Co., Ltd.).

The process of producing the (meth)acrylate compound (2) using the halide process is described below taking an example in which the counter cation X⁺ is shown by the formula (X-1), (X-2), or (X-3). Other ionic liquids such as a sulfur-containing onium salt and a phosphorus-containing onium salt may be produced by a similar process.

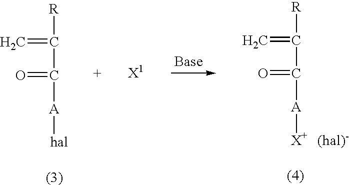

wherein A, R, and X⁺ have the same meanings as defined above, and hal represents a halogen atom such as a chlorine atom, bromine atom, or iodine atom.

Specific examples of X¹ include compounds shown by the following formulas (X¹-1) to (X¹-3).

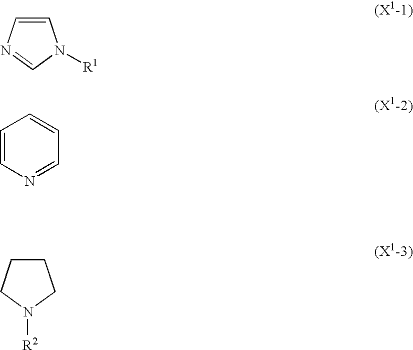

wherein R¹ and R² have the same meanings as defined above.

Specifically, a tertiary amine (X¹) is reacted with a (meth)acrylate shown by the formula (3) to obtain a halide shown by the formula (4).

The halide shown by the formula (4) is then reacted with a salt shown by MY (wherein M represents ammonium, lithium, sodium, potassium, silver, or the like, and Y has the same meaning as defined above) or an acid shown by HY (wherein Y has the same meaning as defined above) to obtain a (meth)acrylate compound shown by the following formula (2a).

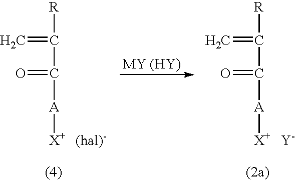

The copolymer formed of two or more types of repeating units shown by the formula (1) which may be utilized as the poly(meth)acrylate compound used in the present invention may be produced by copolymerizing a monomer mixture of two or more types of (meth)acrylate compounds (2).

The copolymer formed of one or more types of repeating units shown by the formula (1) and one or more types of repeating units derived from other copolymerizable monomers which may be utilized as the poly(meth)acrylate compound used in the present invention may be produced by copolymerizing a monomer mixture of one or more types of (meth)acrylate compounds (2) and one or more types of other copolymerizable monomers.

The above-mentioned other copolymerizable monomers are not particularly limited insofar as these monomers are compounds copolymerizable with the (meth)acrylate compound (2). Examples of the above-mentioned other copolymerizable monomers include (meth)acrylates other than the (meth)acrylate compound (2), such as methyl acrylate, methyl methacrylate, ethyl acrylate, ethyl methacrylate, 2-hydroxyethyl acrylate, 2-hydroxyethyl methacrylate, hexyl acrylate, and hexyl methacrylate; (meth)acrylic acids such as acrylic acid and methacrylic acid; aromatic vinyl compounds such as vinyl benzoate, styrene, and α-methylstyrene; unsaturated carboxylic acids such as maleic acid and vinyl phthalate; vinyl ether compounds such as vinylbenzyl methyl ether and vinyl glycidyl ether; conjugated diene compounds such as butadiene and isoprene; and the like.

The (meth)acrylate compound (2) or a mixture of the (meth)acrylate compound (2) and other copolymerizable monomers (hereinafter may be collectively referred to as “(meth)acrylate compound (2) and the like”) may be (co)polymerized using an arbitrary method. For example, an anionic polymerization method, a cationic polymerization method, a radical polymerization method, or the like may be used. It is preferable to use a radical polymerization method since the target product can be obtained in high yield by a simple operation.

Specific examples of the method of polymerizing the (meth)acrylate compound (2) and the like using a radical polymerization method include (a) a method in which the (meth)acrylate compound (2) and the like and a radical polymerization initiator are added to a solvent, and the components are mixed with stirring to effect solution polymerization, (b) a method in which a polymerization reactor is charged with the (meth)acrylate compound (2) and the like, water, and an optional dispersant, the components are mixed with stirring, a radical polymerization initiator is added to the resulting mixture, and the components are further mixed with stirring to effect emulsion polymerization, (c) a method in which a polymerization reactor is charged with water, the (meth)acrylate compound (2) and the like, and a radical polymerization initiator, and the components are mixed with stirring to effect suspension polymerization, and the like.

The radical polymerization initiator used is not particularly limited. Examples of the radical polymerization initiator include peroxides such as hydrogen peroxide, isobutyl peroxide, t-butyl peroxide, octanoyl peroxide, decanoyl peroxide, lauroyl peroxide, benzoyl peroxide, potassium persulfate, ammonium persulfate, and sodium persulfate; azo compounds such as azobisisobutyronitrile, 2,2′-azobis(4-methoxy-2,4-dimethylvaleronitrile), 2,2′-azobis (2-cyclopropylpropionitrile), 2,2′-azobis (2-methylpropionitrile), and 2,2′-azobis(2-methylbutyronitrile); redox initiators such as hydrogen peroxide-ascorbic acid, hydrogen peroxide-ferrous chloride, and persulfate-sodium hydrogensulfite; and the like.

The radical polymerization initiator is added in an amount of normally 0.0005 to 0.01 parts by weight, and preferably 0.002 to 0.007 parts by weight, based on 1 part by weight of the (meth)acrylate compound (2) and the like.

The polymerization temperature is normally 50 to 180° C., and preferably 60 to 90° C., although the polymerization temperature varies depending on the type of the (meth)acrylate compound (2) and the like.

The polymerization reaction is terminated when the polymerization reaction has proceeded to such an extent that the resulting polymer has the desired molecular weight. The end of the polymerization reaction may be checked by sampling the reaction product and measuring the viscosity of the reaction product, for example.

The polymerization time is normally several minutes to several hours, although the polymerization time varies depending on the reaction scale.

The pressure-sensitive adhesive composition according to the present invention includes a base polymer and the above-mentioned poly(meth)acrylate compound as essential components. It is preferable that the pressure-sensitive adhesive composition according to the present invention contain the poly(meth)acrylate compound in an amount of 0.01 to 50 wt % based on the total amount of the composition.

Examples of the base polymer include polymers generally used as a base polymer for a pressure-sensitive adhesive, such as a (meth)acrylic polymer, natural rubber, a styrene-isoprene-styrene block copolymer (SIS block copolymer), a styrene-butadiene-styrene block copolymer (SBS block copolymer), a styrene-ethylene-butylene-styrene block copolymer (SEBS block copolymer), styrene-butadiene rubber, polybutadiene, polyisoprene, polyisobutylene, butyl rubber, chloroprene rubber, and silicone rubber. These base polymers may be used either individually or in combination.

It is preferable to use a (meth)acrylic polymer obtained by polymerizing an alkyl (meth)acrylate having 1 to 14 carbon atoms and one or more types of monomers having a crosslinkable functional group in the molecule, since such a (meth)acrylic polymer exhibits excellent mutual solubility with the poly(meth)acrylate compound and ensures excellent adhesion.

Examples of the alkyl (meth)acrylate having 1 to 14 carbon atoms include methyl (meth)acrylate, ethyl (meth)acrylate, n-butyl (meth)acrylate, s-butyl (meth)acrylate, t-butyl (meth)acrylate, isobutyl (meth)acrylate, hexyl (meth)acrylate, 2-ethylhexyl (meth)acrylate, n-octyl (meth)acrylate, isooctyl (meth)acrylate, n-nonyl (meth)acrylate, isononyl (meth)acrylate, n-decyl (meth)acrylate, isodecyl (meth)acrylate, n-dodecyl (meth)acrylate, n-tridecyl (meth)acrylate, n-tetradecyl (meth)acrylate, and the like.

As the monomer having a crosslinkable functional group in the molecule, it is preferable to use a monomer having at least one of a hydroxyl group, a carboxyl group, an amino group, and an amide group as the functional group. Examples of such a monomer include hydroxyalkyl (meth)acrylates such as 2-hydroxyethyl (meth)acrylate, 2-hydroxypropyl (meth)acrylate, 3-hydroxypropyl (meth)acrylate, 2-hydroxybutyl (meth)acrylate, 3-hydroxybutyl (meth)acrylate, and 4-hydroxybutyl (meth)acrylate; acrylamides such as acrylamide, methacrylamide, N-methylacrylamide, N-methylmethacrylamide, N-methylolacrylamide, and N-methylolmethacrylamide; monoalkylaminoalkyl (meth)acrylates such as monomethylaminoethyl (meth)acrylate, monoethylaminoethyl (meth)acrylate, monomethylaminopropyl (meth)acrylate, and monoethylaminopropyl (meth)acrylate; ethylenically unsaturated carboxylic acids such as acrylic acid, methacrylic acid, crotonic acid, maleic acid, itaconic acid, and citraconic acid; and the like. These monomers may be used either individually or in combination.

The pressure-sensitive adhesive composition according to the present invention may further include an ether group-containing compound in addition to the poly(meth)acrylate compound and the base polymer. A pressure-sensitive adhesive composition which exhibits a more excellent antistatic performance may be obtained by adding the ether group-containing compound to the pressure-sensitive adhesive composition.

The ether group-containing compound is not particularly limited insofar as the compound contains an ether group. A known ether group-containing compound is used as the ether group-containing compound. Examples of the ether group-containing compound include polyether polyol compounds such as polyethylene glycol (diol type), polypropylene glycol (triol type), polytetramethylene ether glycol, derivatives thereof, and random copolymers and block copolymers of polyethylene glycol and polypropylene glycol, such as a polypropylene glycol-polyethylene glycol-polypropylene glycol block copolymer, a polypropylene glycol-polyethylene glycol block copolymer, a polyethylene glycol-polypropylene glycol-polyethylene glycol block copolymer, and a polypropylene glycol-polyethylene glycol random copolymer;

alkylene oxide group-containing compounds such as a polyoxyethylenealkylamine, polyoxypropylenealkylamine, polyoxyethylenediamine, polyoxypropylenediamine, alkylene glycol group-containing (meth) acrylic polymer, alkylene oxide group-containing polyether polymer, alkylene oxide group-containing polyether ester amide, alkylene oxide group-containing polyether amide imide, polyoxyethylene glycol fatty acid ester, polyoxypropylene glycol fatty acid ester, polyoxysorbitan fatty acid ester, polyoxyethylene alkyl phenyl ether, polyoxypropylene alkyl phenyl ether, polyoxyethylene alkyl ether, polyoxypropylene alkyl ether, polyoxyethylene alkyl aryl ether, and polyoxypropylene alkyl aryl ether;
commercially-available ether surfactants such as Adeka Reasoap NE-10, Adeka Reasoap SE-20N, Adeka Reasoap ER-10, Adeka Reasoap SR-1 ON, Adeka Reasoap SR-20N (manufactured by ADEKA CORPORATION), Emulgen 120 (manufactured by Kao Corporation), and Noigen EA130T (manufactured by Dai-ichi Kogyo Seiyaku Co., Ltd.); and the like.

The pressure-sensitive adhesive composition according to the present invention may further include known additives such as a tackifier, a surface lubricant, a leveling agent, an antioxidant, a corrosion inhibitor, a light stabilizer, a UV absorber, a polymerization inhibitor, a silane coupling agent, an inorganic or organic filler, a powder such as a metal powder and a pigment, particles, flakes, a crosslinking agent (described later), and a polyfunctional monomer (described later), depending on the application.

The pressure-sensitive adhesive composition according to the present invention may be prepared by dissolving specific amounts of the poly(meth)acrylate compound, an optional base polymer, and optional additives in an appropriate solvent.

Examples of the solvent include ketone solvents such as acetone, methyl ethyl ketone, diethyl ketone, methyl isobutyl ketone, and cyclohexanone; ester solvents such as ethyl acetate, propyl acetate, and butyl acetate; ether solvents such as 1,2-dimethoxyethane, tetrahydrofuran, and 1,4-dioxane; halogenated solvents such as chloroform, carbon tetrachloride, and chlorobenzene; aromatic hydrocarbon solvents such as benzene, toluene, and xylene; amide solvents such as N,N-dimethylformamide, N,N-dimethylacetamide, and N-methylpyrrolidone; aliphatic hydrocarbon solvents such as pentane, hexane, and heptane; alicyclic hydrocarbon solvents such as cyclopentane and cyclohexane; a mixed solvent of two or more of these solvents; and the like.

The solid content of the pressure-sensitive adhesive composition according to the present invention is not particularly limited, but may be appropriately set taking the coating liquid handling capability and the like into consideration. It is normally about 10 to 60 wt %.

### 2) Pressure-Sensitive Adhesive Layer

The pressure-sensitive adhesive layer according to the present invention is preferably formed of a crosslinked product of the pressure-sensitive adhesive composition according to the present invention.

The pressure-sensitive adhesive composition is normally crosslinked after applying the pressure-sensitive adhesive composition. Note that a pressure-sensitive adhesive layer formed of a crosslinked product of the pressure-sensitive adhesive composition may be transferred to a support film or the like.

The pressure-sensitive adhesive according to the present invention may optionally include a crosslinking agent. The crosslinking agent is not particularly limited. An appropriate compound may be selected from compounds generally used as a crosslinking agent for an acrylic pressure-sensitive adhesive.

Specific examples of the crosslinking agent include an isocyanate compound, an epoxy compound, a melamine resin, an aziridine compound, and the like. In particular, an isocyanate compound or an epoxy compound is preferably used from the viewpoint of obtaining a moderate cohesive force. These compounds may be used either individually or in combination.

Examples of the isocyanate compound include lower aliphatic polyisocyanates such as butylene diisocyanate and hexamethylene diisocyanate; alicyclic isocyanates such as cyclopentylene diisocyanate, cyclohexylene diisocyanate, and isophorone diisocyanate; aromatic diisocyanates such as 2,4-tolylene diisocyanate, 4,4′-diphenylmethane diisocyanate, and xylylene diisocyanate; a trimethylolpropane/tolylene diisocyanate tri-adduct product (“Coronate L” manufactured by Nippon Polyurethane Industry Co., Ltd. and “BHS-8515” manufactured by Toyo Ink Mfg. Co., Ltd.), a trimethylolpropane/hexamethylene diisocyanate tri-adduct product (“Coronate HL” manufactured by Nippon Polyurethane Industry Co., Ltd.), hexamethylene diisocyanate isocyanurate (“Coronate HX” manufactured by Nippon Polyurethane Industry Co., Ltd.); and the like. These isocyanate compounds may be used either individually or in combination.

Examples of the epoxy compound include N,N,N′,N′-tetraglycidyl-m-xylenediamine (“TETRAD-X” manufactured by Mitsubishi Gas Chemical Company, Inc.), 1,3-bis(N,N-diglycidylaminomethyl)cyclohexane (“TETRAD-C” manufactured by Mitsubishi Gas Chemical Company, Inc.), and the like. These compounds may be used either individually or in combination.

Examples of the melamine resin include hexamethylolmelamine and the like.

Examples of the aziridine compound include HDU (manufactured by Sogo Pharmaceutical Co., Ltd.), TAZM (manufactured by Sogo Pharmaceutical Co., Ltd.), TAZO (manufactured by Sogo Pharmaceutical Co., Ltd.), and the like. These compounds may be used either individually or in combination.

The crosslinking agent may be added in advance to the pressure-sensitive adhesive composition according to the present invention.

The amount of the crosslinking agent is appropriately selected depending on the balance between the poly(meth)acrylate compound and the base polymer to be crosslinked (hereinafter may be collectively referred to as “base polymer component”), and the application of the resulting pressure-sensitive adhesive sheet. In order to obtain sufficient heat resistance due to the cohesive force of the acrylic pressure-sensitive adhesive, the crosslinking agent is preferably used in an amount of 0.01 to 15 parts by weight, and more preferably 0.5 to 10 parts by weight, based on 100 parts by weight of the base polymer component.

If the amount of the crosslinking agent is less than 0.01 parts by weight, crosslinking due to the crosslinking agent may become insufficient, whereby sufficient heat resistance may not be obtained due to a decrease in the cohesive force of the pressure-sensitive adhesive composition. Moreover, an adhesive residue may occur. If the amount of the crosslinking agent exceeds 15 parts by weight, fluidity may decrease due to an increase in the cohesive force of the base polymer component, whereby wettability with an adherend may become insufficient. As a result, peeling may occur.

A polyfunctional monomer having two or more radiation-reactive unsaturated bonds (hereinafter may be referred to as “polyfunctional monomer”) may be added and crosslinked by applying radiation or the like.

As the polyfunctional monomer, a polyfunctional monomer component having two or more radiation-reactive unsaturated bonds of one or more types which can be crosslinked (cured) by applying radiation (e.g., vinyl group, acryloyl group, methacryloyl group, and vinylbenzyl group) is used. A polyfunctional monomer having ten or less radiation-reactive unsaturated bonds is preferably used. Two or more types of polyfunctional monomers may be used in combination.

Specific examples of the polyfunctional monomer include bifunctional monomers such as ethylene glycol di(meth)acrylate, diethylene glycol di(meth)acrylate, neopentyl glycol di(meth)acrylate, 1,6-hexanediol di(meth)acrylate, tetraethylene glycol di(meth)acrylate, 1,4-butanediol di(meth)acrylate, polyethylene glycol di(meth)acrylate, neopentyl glycol adipate di(meth)acrylate, hydroxypivalate neopentyl glycol di(meth)acrylate, dicyclopentanyl di(meth)acrylate, caprolactone-modified dicyclopentenyl di(meth)acrylate, ethylene oxide-modified phosphoric acid di(meth)acrylate, di(acryloxyethyl)isocyanurate, allylated cyclohexyl di(meth)acrylate, divinylbenzene, and N,N′-methylenebisacrylamide; trifunctional monomers such as trimethylolpropane tri(meth)acrylate, pentaerythritol tri(meth)acrylate, propionic acid-modified dipentaerythritol tri(meth)acrylate, propylene oxide-modified trimethylolpropane tri(meth)acrylate, and tris(acryloxyethyl)isocyanurate; tetrafunctional monomers such as diglycerol tetra(meth)acrylate and pentaerythritol tetra(meth)acrylate; pentafunctional monomers such as propionic acid-modified dipentaerythritol penta(meth)acrylate; hexafunctional monomers such as dipentaerythritol hexa(meth)acrylate and caprolactone-modified dipentaerythritol hexa(meth)acrylate; and the like.

The polyfunctional monomer may be added in advance to the pressure-sensitive adhesive composition according to the present invention.

The amount of the polyfunctional monomer is appropriately selected depending on the balance between the polyfunctional monomer and the base polymer component to be crosslinked and the application of the resulting pressure-sensitive adhesive sheet. The polyfunctional monomer is preferably used in an amount of 0.1 to 30 parts by weight based on 100 parts by weight of the base polymer component to be crosslinked.

Examples of the radiation include ultra-violet (UV) rays, α-rays, β-rays, γ-rays, X-rays, electron beams, and the like. It is preferable to use UV rays from the viewpoint of controllability, handling capability, and cost. It is more preferable to use UV rays with a wavelength of 200 to 400 nm.

UV rays may be applied using an appropriate light source such as a high-pressure mercury lamp, a microwave-excitated lamp, or a chemical lamp. When using UV rays as the radiation, a photoinitiator is added to the pressure-sensitive adhesive.

The photoinitiator may be a substance that generates radicals or cations upon application of UV rays with an appropriate wavelength that may cause a polymerization reaction, depending on the type of radiation-reactive component.

Examples of a radical photoinitiator include benzoins such as benzoin, benzoin methyl ether, benzoin ethyl ether, methyl o-benzoylbenzoate-p-benzoin ethyl ether, benzoin isopropyl ether, and α-methylbenzoin; acetophenones such as benzyl dimethyl ketal, trichloroacetophenone, 2,2-diethoxyacetophenone, 1-hydroxycyclohexyl phenyl ketone, and 2,2-dimethoxy-1,2-diphenylethan-1-one; propiophenones such as 2-hydroxy-2-methylpropiophenone and 2-hydroxy-4′-isopropyl-2-methylpropiophenone; benzophenones such as benzophenone, methylbenzophenone, p-chlorobenzophenone, and p-dimethylaminobenzophenone; thioxanethones such as 2-chlorothioxanethone, 2-ethylthioxanthone, and 2-isopropylthioxanthone; acylphosphine oxides such as bis(2,4,6-trimethylbenzoyl)-phenylphosphine oxide, 2,4,6-trimethylbenzoyldiphenylphosphine oxide, and (2,4,6-trimethylbenzoyl)-(ethoxy)-phenylphosphine oxide; benzyl; dibenzosuberone; α-acyloxime ester; and the like.

A photopolymerization initiation assistant such as an amine may be used in combination with the radical photoinitiator. Examples of the photopolymerization initiation assistant include 2-dimethylaminoethyl benzoate, dimethylaminoacetophenone, ethyl p-dimethylaminobenzoate, isoamyl p-dimethylaminobenzoate, and the like. These photopolymerization initiation assistants may be used in combination.

Examples of a cationic photoinitiator include onium salts such as an aromatic diazonium salt, aromatic iodonium salt, and aromatic sulfonium salt; organic metal complexes such as an iron-allene complex, titanocene complex, and arylsilanol-aluminum complex; esters such as a nitrobenzyl ester, sulfonic acid derivative, phosphate, and phenol sulfonate; diazonaphthoquinone; N-hydroxyimide sulfonate; and the like. These photoinitiators may be used in combination.

The photoinitiator is normally used in an amount of 0.1 to 10 parts by weight, and preferably 0.2 to 7 parts by weight, based on 100 parts by weight of the base polymer component.

The photopolymerization initiation assistant is preferably used in an amount of 0.05 to 10 parts by weight, and preferably 0.1 to 7 parts by weight, based on 100 parts by weight of the base polymer component.

When adding the photoinitiator as an optional component, a pressure-sensitive adhesive layer may be obtained by directly applying the pressure-sensitive adhesive composition to a protection target object or applying the pressure-sensitive adhesive composition to one side or each side of a support substrate, and applying light to the pressure-sensitive adhesive composition. A pressure-sensitive adhesive layer is normally obtained by applying UV rays with an illuminance at a wavelength of 200 to 400 nm of 1 to 1000 mW/cm² at a dose of 100 to 4000 mJ/cm² to effect photopolymerization.

The thickness of the pressure-sensitive adhesive layer according to the present invention is normally about 3 to 100 μm, and preferably about 5 to 50 μm.

### 3) Pressure-Sensitive Adhesive Sheet

The pressure-sensitive adhesive sheet according to the present invention includes the pressure-sensitive adhesive layer according to the present invention, the pressure-sensitive adhesive layer being provided on one side or both sides of a support.

Examples of the support include a plastic substrate, a porous material (e.g., paper or nonwoven fabric), and the like. When the pressure-sensitive adhesive sheet according to the present invention is used as a surface protective film, it is preferable to use a plastic substrate as the support since a remarkable antistatic effect is achieved.

The plastic substrate is not particularly limited insofar as the plastic substrate can be formed in the shape of a sheet or a film. Examples of (the material for) the plastic substrate include polyolefin resins such as polyethylene, polypropylene, poly1-1-butene, poly-4-methyl-1-pentene, an ethylene-propylene copolymer, an ethylene-1-butene copolymer, an ethylene-vinyl acetate copolymer, an ethylene-ethyl acrylate copolymer, and an ethylene-vinyl alcohol copolymer; polyester resins such as polyethylene terephthalate, polyethylene naphthalate, and polybuthylene terephthalate; polyacrylate; polystyrene; polyamides such as nylon 6, nylon 6,6, and a partially aromatic polyamide; polyvinyl chloride; polyvinylidene chloride; polycarbonate; cellulose polymers such as triacetyl cellulose; and the like.

The thickness of the plastic substrate is normally about 5 to 200 μm, and preferably about 10 to 100 μm.

The plastic substrate used may optionally be provided with a treatment with a release agent such as silicone-based release agent, a fluorine-based release agent, or a long-chain alkyl or fatty acid amide-based release agent; a mold-release/stain-proof treatment with a silica powder; an adhesion enhancement treatment such as an acid treatment, an alkali treatment, a primer treatment, a corona treatment, a plasma treatment, and a UV treatment; antireflection treatment by a coating type, a blending antireflection treatment, or a deposition antireflection treatment; and the like.

The plastic substrate used may be provided with an antistatic treatment.

The antistatic treatment applied to the plastic substrate is not particularly limited. Examples of the antistatic treatment include a method which provides an antistatic layer on at least one side of a plastic film, and a method which mixes an antistatic agent in the plastic film.

An antistatic layer may be provided on at least one side of a plastic film by applying an antistatic resin formed of an antistatic agent and a resin component, a conductive polymer, or a conductive resin containing a conductive substance, or depositing or plating a conductive substance, for example.

The thickness of the antistatic resin, the conductive polymer, and the conductive resin is normally about 0.01 to 5 μm, and preferably about 0.03 to 1 μm.

A conductive substance may be deposited or plated by vacuum deposition, sputtering, ion plating, chemical vapor deposition, spray pyrolysis, chemical plating, electroplating, or the like.

A release film may be bonded to the surface of the pressure-sensitive adhesive of the pressure-sensitive adhesive sheet according to the present invention in order to protect the adhesive face. A substrate of the release film may be paper or a plastic film. A plastic film is preferably used due to excellent surface flatness.

### EXAMPLES

The present invention is described in more detail below by way of examples. Note that the present invention is not limited to the following examples.

The chemical structure, the molecular weight, and the melting point of the resulting polymerized ionic liquid (poly(meth)acrylate compound) were determined by the following methods (i.e., NMR, GPC, and DSC).

### (1) NMR

The chemical structure was determined using an NMR measurement device (“AVANCE 500” manufactured by Bruker BioSpin K.K.) at a frequency of 500 Hz.

### (2) GPC

The molecular weight was determined using a GPC measurement device (“HCL-8020” manufactured by Tosoh Corp.) and polystyrene gel columns (TSK gel GMH-XL, GMH-XL, G2000H-XL) (solvent: THF) at a flow rate of 1 mL/min and a temperature of 40° C. The weight average molecular weight (Mw) was calculated from a standard polystyrene-reduced value.

### (3) Melting Point

Measurements were carried out using a differential scanning calorimeter (DSC: Pyris-I manufactured by PerkinElmer Inc.) in the range of −100° C. to +100° C. (scanning velocity: 20° C./min). The melting point was calculated from the DSC endoergic peak.

### Synthesis Example 1

### Synthesis of 3-(1-ethylimidazolium-3-yl)propyl methacrylate bis(trifluoromethanesulfonyl)imide (IL Monomer 1)

10.0 g of 3-bromo-1-propanol (71.9 mmol, manufactured by Tokyo Kasei Kogyo Co., Ltd.) and 8.46 g of triethylamine (83.8 mmol, manufactured by Tokyo Kasei Kogyo Co., Ltd) were dissolved in 100 ml of diethyl ether. 100 ml of a diethyl ether solution of methacrylic acid chloride (8.63 g (83.0 mmol)) was added dropwise to the solution at 0° C. over 20 minutes. After the addition, the mixture was stirred for 24 hours. The reaction product was filtered to remove insoluble components, and the diethyl ether was evaporated under reduced pressure. The resulting viscous liquid was distilled under reduced pressure (50 to 52° C./4×10⁵ Pa) to obtain 10.8 g (56.0 mmol) of 3-bromopropyl methacrylate (yield: 78%).

4.20 g (21.8 mmol) of the resulting 3-bromopropyl methacrylate was dissolved in 40 ml of dehydrated acetonitrile. The resulting solution was put in a dropping funnel. 2.31 g of N-ethylimidazole (1.1-fold excess) (24.0 mmol, manufactured by Tokyo Kasei Kogyo Co., Ltd.) was dissolved in 25 ml of dehydrated acetonitrile, and the resulting solution was put in a 200 ml eggplant shaped flask. The acetonitrile solution of 3-bromopropyl methacrylate was added dropwise to the eggplant shaped flask in an ice bath over 30 minutes. After the addition, the mixture was stirred at room temperature for 24 hours.

The solvent was evaporated from the reaction liquid under reduced pressure. After repeated decantation by diethylether, the resulting product was purified by pumping to obtain 2.29 g (7.92 mmol) of 3-(1-ethylimidazolium-3-yl)propyl methacrylate bromide (i.e., a monomer having ethylimidazole in the side chain) (yield: 33%).

2.29 g (7.92 mmol) of 3-(1-ethylimidazolium-3-yl)propyl methacrylate bromide was dissolved in 20 g of purified water. The solution was mixed with 3.41 g of lithium bis(trifluoromethanesulfonyl)imide (11.88 mmol, manufactured by Tokyo Kasei Kogyo Co., Ltd.) (dissolved in 20 g of purified water) at room temperature. The mixture was then stirred for three hours. After decantation by water, the product was extracted with dichloromethane to obtain 2.01 g (4.09 mmol) of 3-(1-ethylimidazolium-3-yl)propyl methacrylate bis(trifluoromethanesulfonyl)imide (yield: 51%).

It was confirmed that the desired monomer was obtained because a peak specific to the desired monomer was observed by NMR measurement. The melting point of the resulting monomer was −72° C.

### Synthesis Example 2

### Homopolymerization of 3-(1-ethylimidazolium-3-yl)propyl methacrylate bis(trifluoromethanesulfonyl)imide (Production of Poly IL1)

4.44 g (8.83 mmol) of 3-(1-ethylimidazolium-3-yl)propyl methacrylate bis(trifluoromethanesulfonyl)imide synthesized in Synthesis Example 1 was dissolved in 10 ml of methyl ethyl ketone (MEK). Then, 0.0218 g (0.379 mmol) of azoisobutyronitrile (AIBN) was dissolved in the resulting solution. After several deaerations, the components were reacted at 65° C. for 15 hours to obtain a homopolymer of 3-(1-ethylimidazolium-3-yl)propyl methacrylate bis(trifluoromethanesulfonyl)imide (Mw=2100). The resulting polymer is hereinafter referred to as “Poly IL1”.

It was confirmed that the desired polymer was obtained because a peak specific to the desired polymer was observed by NMR measurement. The melting point of the resulting polymer was −38° C.

### Synthesis Example 3

### Synthesis of 3-(3-methylpyridinium)propyl methacrylate bis(trifluoromethanesulfonyl)imide (IL Monomer 2)

10.0 g (48.3 mmol) of 3-bromopropyl methacrylate synthesized in Synthesis Example 1 and 4.50 g of 3-methylpyridine (48.3 mmol, manufactured by Tokyo Kasei Kogyo Co., Ltd.) were dissolved in 100 ml of dehydrated acetonitrile. The mixture was stirred at room temperature for 24 hours. The reaction product was reprecipitated in diethyl ether to obtain 3.60 g (12.0 mmol) of 3-(1-methylpyridinium)propyl methacrylate bromide (yield: 32%). The resulting 3-(1-methylpyridinium)propyl methacrylate bromide was dissolved in 20 ml of purified water. The solution was mixed with 0.96 g of lithium bis(trifluoromethanesulfonyl)imide (3.34 mmol, manufactured by Tokyo Kasei Kogyo Co., Ltd.) (dissolved in 20 ml of purified water). The mixture was then stirred at room temperature for three hours. After completion of the reaction, the purified water was decanted off. The product was then extracted with dichloromethane to obtain 1.75 g (3.50 mmol) of 3-(3-methylpyridinium)propyl methacrylate bis(trifluoromethanesulfonyl)imide (yield: 75%).

It was confirmed that the desired monomer was obtained because a peak specific to the desired monomer was observed by NMR measurement. The melting point of the resulting monomer was −65° C.

### Synthesis Example 4

### Homopolymerization of 3-(3-methylpyridinium)propyl methacrylate bis(trifluoromethanesulfonyl)imide (Production of Poly IL2)

1.75 g (6.00 mmol) of 3-(3-methylpyridinium)propyl methacrylate bis(trifluoromethanesulfonyl)imide synthesized in Synthesis Example 3 was dissolved in 3 ml of ethyl acetate. Then, 0.024 g (0.290 mmol) of AIBN was dissolved in the resulting solution. After several deaerations, the components were reacted at 65° C. for seven hours to obtain a homopolymer of 3-(3-methylpyridinium)propyl methacrylate bis(trifluoromethanesulfonyl)imide (Mw=2500). The resulting polymer is hereinafter referred to as “Poly IL2”.

It was confirmed that the desired polymer was obtained because a peak specific to the desired polymer was observed by NMR measurement. The melting point of the resulting polymer was −30° C.

### Example 1

A separable flask (1 liter) was charged with 180 parts by weight of butyl acrylate and 20 parts by weight of acrylic acid. Then, 0.20 parts by weight of AIBN (polymerization initiator) and 300 parts by weight of ethyl acetate were added to the mixture. The components were reacted at 65° C. for 10 hours in a nitrogen atmosphere to obtain a butyl acrylate-acrylic acid copolymer (butyl acrylate:acrylic acid=90:10) (Mw=1,000,000, solid content: 40%). The resulting copolymer is hereinafter referred to as “Poly1”.

0.5 parts by weight of an isocyanate-based crosslinking agent (“Oribain BHS-8515” manufactured by Toyo Ink Mfg. Co., Ltd.) and 1.0 part by weight of Poly IL1 obtained in Synthesis Example 2 were added to 100 parts by weight of Poly1. The solid content of the mixture was adjusted to 38 wt % by adding methyl ethyl ketone. The mixture was stirred until a homogenous liquid was obtained to prepare a coating liquid. The coating liquid was applied to the surface of a polyethylene terephthalate (PET) sheet using a knife coater. The resulting coating was dried at 100° C. for 90 seconds to form a pressure-sensitive adhesive layer with a thickness of 20 μm on the PET sheet.

The PET sheet was attached to a release film (thickness: 38 μm; a release agent layer was provided on a PET sheet) (“PET38GS” manufactured by Lintec Corporation) so that the release agent layer came into contact with the pressure-sensitive adhesive layer to obtain a pressure-sensitive adhesive sheet.

### Example 2

A mixed liquid was stirred, applied, and dried in the same manner as in Example 1, except that Poly IL1 was added in an amount of 5.0 parts by weight. The resulting product was attached to a release film in the same manner as in Example 1 to form a pressure-sensitive adhesive sheet.

### Example 3

A mixed liquid was stirred, applied, and dried in the same manner as in Example 1, except that Poly ILL was added in an amount of 10.0 parts by weight. The resulting product was attached to a release film in the same manner as in Example 1 to form a pressure-sensitive adhesive sheet.

### Example 4

15 parts by weight of tris(acryloxyethyl)isocyanurate (“Aronix M-315” manufactured by Toagosei Co., Ltd., hereinafter the same) (polyfunctional acrylate monomer), 1.5 parts by weight of 2,2-dimethoxy-1,2-diphenylethan-1-one (“Irgacure 651” manufactured by Ciba Specialty Chemicals Co., Ltd., hereinafter the same) (photoinitiator), 3.0 parts by weight of a hexamethylene diisocyanate tri-adduct (“Coronate HX” manufactured by Nippon Polyurethane Industry Co., Ltd., hereinafter the same) (isocyanate-based crosslinking agent), and 2.5 parts by weight of Poly IL1 obtained in Synthesis Example 3 were added to 100 parts by weight of Poly1. The solid content of the mixture was adjusted to 38 wt % by adding methyl ethyl ketone. The mixed liquid was stirred, applied, and dried, and the resulting product was attached to a release film in the same manner as in Example 1.

Ultra-violet (UV) rays were applied to the resulting product under the following conditions to form a pressure-sensitive adhesive sheet.

### UV Irradiation Conditions

Electrodeless lamp (H valve) manufactured by Fusion, illuminance: 600 mW/cm², dose: 150 mJ/cm²

A UV irradiation system UVPF-36 (manufactured by Eyegraphics Co., Ltd.) was used.

### Example 5

A mixed liquid was stirred, applied, and dried in the same manner as in Example 4, except that Poly IL1 was added in an amount of 5.0 parts by weight. The resulting product was attached to a release film and irradiated with UV rays in the same manner as in Example 4 to form a pressure-sensitive adhesive sheet.

### Example 6

A separable flask (1 liter) was charged with 194 parts by weight of butyl acrylate and 6 parts by weight of 2-hydroxyethyl acrylate. Then, 0.20 parts by weight of AIBN (polymerization initiator) and 300 parts by weight of ethyl acetate were added to the mixture. The components were reacted at 65° C. for eight hours in a nitrogen atmosphere to obtain a butyl acrylate-2-hydroxyethyl acrylate copolymer (butyl acrylate:2-hydroxyethyl acrylate=97:3) (hereinafter referred to as “Poly2”, Mw=1,000,000, solid content: 40%).

10 parts by weight of Poly1, 15 parts by weight of tris(acryloxyethyl)isocyanurate, 1.5 parts by weight of 2,2-dimethoxy-1,2-diphenylethan-1-one, 3 parts by weight of a hexamethylene diisocyanate tri-adduct, and 2.5 parts by weight of Poly IL1 obtained in Synthesis Example 3, were added to 100 parts by weight of Poly2. The solid content of the mixture was adjusted to 38 wt % by adding methyl ethyl ketone. The mixed liquid was stirred, applied, dried, and irradiated with UV rays in the same manner as in Example 4 to form a pressure-sensitive adhesive sheet.

### Example 7

A mixed liquid was stirred, applied, and dried in the same manner as in Example 6, except that Poly IL1 was added in an amount of 5.0 parts by weight. The resulting product was attached to a release film and irradiated with UV rays in the same manner as in Example 6 to form a pressure-sensitive adhesive sheet.

### Example 8

A mixed liquid was stirred, applied, and dried in the same manner as in Example 1, except that 5.0 parts by weight of Poly IL2 was added instead of 1.0 part by weight of Poly IL1. The resulting product was attached to a release film in the same manner as in Example 1 to form a pressure-sensitive adhesive sheet.

### Comparative Example 1

A mixed liquid was stirred, applied, and dried in the same manner as in Example 1, except that Poly IL1 was not added. The resulting product was attached to a release film in the same manner as in Example 1 to form a pressure-sensitive adhesive sheet.

### Comparative Example 2

A mixed liquid was stirred, applied, and dried in the same manner as in Example 1, except that 5.0 parts by weight of 3-(1-ethylimidazolium-3-yl)propyl methacrylate bis(trifluoromethanesulfonyl)imide (IL monomer 1) obtained in Synthesis Example 1 was added instead of 1.0 part by weight of Poly IL1. The resulting product was attached to a release film in the same manner as in Example 1 to form a pressure-sensitive adhesive sheet.

### Comparative Example 3

A mixed liquid was stirred, applied, and dried in the same manner as in Example 1, except that 5.0 parts by weight of 3-(3-methylpyridinium)propyl methacrylate bis(trifluoromethanesulfonyl)imide (IL monomer 2) obtained in Synthesis Example 3 was added instead of 1.0 part by weight of Poly IL1. The resulting product was attached to a release film in the same manner as in Example 1 to form a pressure-sensitive adhesive sheet.

Table 1 shows the types of the acrylic copolymer, the polyfunctional monomer, the crosslinking agent, and the photoinitiator used to form the pressure-sensitive adhesive sheet in Examples 1 to 8 and Comparative Examples 1 to 3, and the amounts of the acrylic copolymer, the polyfunctional monomer, Poly IL, the IL monomer, the crosslinking agent, and the photoinitiator used in Examples 1 to 8 and Comparative Examples 1 to 3.

Symbols shown in Table 1 have the following meanings.

### (Polyfunctional Monomer)

A: Tris(acryloxyethyl)isocyanurate (“Aronix M-315” manufactured by Toagosei Co., Ltd.)

### (Crosslinking Agent)

A: Isocyanate-based crosslinking agent (“Oribain BHS-8515” manufactured by Toyo Ink Mfg. Co., Ltd.)
B: Hexamethylene diisocyanate tri-adduct (“Coronate HX” manufactured by Nippon Polyurethane Industry Co., Ltd.)

### (Photoinitiator)

A: 2,2-Dimethoxy-1,2-diphenylethane-1-one (“Irgacure 651” manufactured by Ciba Specialty Chemicals Co., Ltd.)

### (Poly IL)

1: Polymer of 3-(1-ethylimidazolum-3-yl)propyl methacrylate bis(trifluoromethanesulfonyl)imide
2: Polymer of 3-(3-methylpyridinium)propyl methacrylate bis(trifluoromethanesulfonyl)imide

### (IL Monomer)

IL1: 3-(1-ethylimidazolum-3-yl)propyl methacrylate bis(trifluoromethanesulfonyl)imide
IL2: 3-(3-methylpyridinium)propyl methacrylate bis(trifluoromethanesulfonyl)imide

TABLE 1

| | | | Polyfunctional | | | | |
|---|---|---|---|---|---|---|---|
| | Acrylic copolymer | | monomer | Poly IL | Crosslinking agent | Photoinitiator | IL monomer |
| | Type | Parts by weight | Parts by weight | Parts by weight | Parts by weight | Parts by weight | Parts by weight |
| Example 1 | Poly1 | 100 | — | 1 (1.0) | A (0.5) | — | — |
| Example 2 | Poly1 | 100 | — | 1 (5.0) | A (0.5) | — | — |
| Example 3 | Poly1 | 100 | — | 1 (10.0) | A (0.5) | — | — |
| Example 4 | Poly1 | 100 | A (15) | 1 (2.5) | B (3.0) | A (1.5) | — |
| Example 5 | Poly1 | 100 | A (15) | 1 (5.0) | B (3.0) | A (1.5) | — |
| Example 6 | Poly1 | 10 | A (15) | 1 (2.5) | B (3.0) | A (1.5) | — |
| | Poly2 | 100 | | | | | |
| Example 7 | Poly1 | 10 | A (15) | 1 (5.0) | B (3.0) | A (1.5) | — |
| | Poly2 | 100 | | | | | |
| Example 8 | Poly1 | 100 | — | 2 (5.0) | A (0.5) | — | — |
| Comparative Example 1 | Poly1 | 100 | — | — | A (0.5) | — | — |
| Comparative Example 2 | Poly1 | 100 | — | — | A (0.5) | — | (IL1) 5 |
| Comparative Example 3 | Poly1 | 100 | — | — | A (0.5) | — | (IL2) 5 |

### Pressure-Sensitive Adhesive Sheet Performance Evaluation Tests

The performance of the pressure-sensitive adhesive sheets obtained in Examples 1 to 8 and Comparative Examples 1 to 3 was evaluated by the following methods.

### (1) Measurement of Surface Resistivity

Immediately after removing the release film, the surface resistivity of the pressure-sensitive adhesive layer was measured under reference atmosphere conditions (temperature: 23° C., relative humidity: 50%) using a surface resistivity measurement device (“R8252” manufactured by Advantest Corporation) (applied voltage: 100 V). The measurement results are shown in Table 2.

### (2) Measurement of Static Voltage

Immediately after removing the release film, the static voltage of the pressure-sensitive adhesive layer was measured under reference atmosphere conditions (temperature: 23° C., relative humidity: 50%) using a static voltage measurement device (“Static Honest Meter S-5109” manufactured by Shishido Electrostatic, Ltd.) (direct current: 10 kV, revolution: 1300 rpm). The measurement results are shown in Table 2.

### (3) Measurement of Adhesion

The adhesion of the pressure-sensitive adhesive sheet allowed to stand for one day under reference atmosphere conditions (temperature: 23° C., relative humidity: 50%) and the pressure-sensitive adhesive sheet allowed to stand for seven days at a temperature of 60° C. and a relative humidity of 90% and for one day under the reference atmosphere conditions was measured in accordance with JIS Z 0237 (adherend: 307SUS). The measurement results are shown in Table 2.

In Table 2, the column “reference atmosphere” indicates the adhesion (N/25 mm) of the pressure-sensitive adhesive sheet allowed to stand for one day under reference atmosphere conditions (temperature: 23° C., relative humidity: 50%) measured in accordance with JIS Z 0237, and the column “temperature: 60° C., relative humidity: 90%” indicates the adhesion (N/25 mm) of the pressure-sensitive adhesive sheet allowed to stand for seven days at a temperature of 60° C. and a relative humidity of 90% and for one day under the reference atmosphere conditions measured in accordance with JIS Z. 0237.

TABLE 2

| | Adhesion | | | |
|---|---|---|---|---|
| | | Temperature: | | |
| | | 60° C., | | |
| | Reference | relative humidity: | Surface | Static |
| | atmosphere | 90% | resistivity | voltage |
| | N/25 mm | N/25 mm | ohm/square | kV |
| Example 1 | 20.6 | 19.6 | 9 × 10¹² | 1.3 |
| Example 2 | 19.3 | 18.3 | 5 × 10¹² | 1.1 |
| Example 3 | 19.9 | 18.8 | 8 × 10¹¹ | 0.9 |
| Example 4 | 20.1 | 19.3 | 9 × 10¹¹ | 1.1 |
| Example 5 | 19.8 | 19.0 | 4 × 10¹¹ | 0.9 |
| Example 6 | 20.3 | 20.5 | 7 × 10¹¹ | 1.0 |
| Example 7 | 19.6 | 18.9 | 2 × 10¹¹ | 0.8 |
| Example 8 | 20.0 | 19.5 | 7 × 10¹² | 1.3 |
| Comparative | 20.3 | 19.4 | 6 × 10¹⁵ | 2.1 |
| Example 1 | | | | |
| Comparative | 19.3 | 16.0 | 3 × 10¹¹ | 0.9 |
| Example 2 | | | | |
| Comparative | 19.5 | 15.9 | 3 × 10¹¹ | 0.9 |
| Example 3 | | | | |

As shown in Table 2, the pressure-sensitive adhesive sheets of Examples 1 to 8 had a low surface resistivity and excellent static voltage properties. Moreover, the adhesion of the pressure-sensitive adhesive did not decrease even when the pressure-sensitive adhesive sheets were subjected to a high-temperature/high-humidity environment (temperature: 60° C., relative humidity: 90%).

The pressure-sensitive adhesive sheet of Comparative Example 1 prepared without adding Poly IL (polymerized ionic liquid) and the IL monomer did not show a decrease in adhesion of the pressure-sensitive adhesive even when subjected to a high-temperature/high-humidity environment (temperature: 60° C., relative humidity: 90%), but had a high surface resistivity and a high static voltage.

The pressure-sensitive adhesive sheets of Comparative Examples 2 and 3 prepared using the IL monomer without adding Poly IL (polymerized ionic liquid) had a low surface resistivity and excellent static voltage properties, but showed a decrease in adhesion of the pressure-sensitive adhesive even when subjected to a high-temperature/high-humidity environment (temperature: 60° C., relative humidity: 90%).

1. A pressure-sensitive adhesive composition comprising a poly(meth)acrylate compound that contains a repeating unit shown by the following formula (1) in its molecule and has a melting point of 50° C. or less, 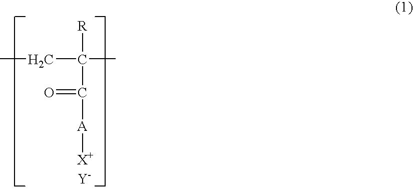
wherein X⁺ and Y⁻ represent a combination of a counter cation and a counter anion which may form an ion pair, R represents a hydrogen atom or a methyl group, and A represents a linking group.

2. The pressure-sensitive adhesive composition according to claim 1, wherein X⁺ in the formula (1) is a nitrogen-containing onium, a sulfur-containing onium, or a phosphorus-containing onium.

3. The pressure-sensitive adhesive composition according to claim 1 or 2, wherein A in the formula (1) is a group shown by *—(CH₂)ₙO— (wherein n represents an integer from 1 to 6, and * represents a position at which A is bonded to X⁺).

4. The pressure-sensitive adhesive composition according to claim 1, wherein the pressure-sensitive adhesive composition contains the poly(meth)acrylate compound in an amount of 0.01 to 50 wt % based on the total amount of the composition.

5. A pressure-sensitive adhesive layer comprising a crosslinked product of the pressure-sensitive adhesive composition according to claim 1.

6. A pressure-sensitive adhesive sheet comprising the pressure-sensitive adhesive layer according to claim 5 and a support, the pressure-sensitive adhesive layer being provided on one side or both sides of the support material.
